(19) United States
(12) Patent Application Publication
(10) Pub. No.: US 2025/0093177 A1
(43) Pub. Date: Mar. 20, 2025

(54) METHOD AND DEVICE FOR CREATING A DIGITAL MAP AND OPERATING AN AUTOMATED VEHICLE

(71) Applicant: Robert Bosch GmbH, Stuttgart (DE)

(72) Inventors: Markus Schuetz, Tuebingen (DE); Steffen Knoop, Hohenwettersbach (DE)

(21) Appl. No.: 18/824,404

(22) Filed: Sep. 4, 2024

(30) Foreign Application Priority Data
Sep. 14, 2023 (DE) 10 2023 208 926.2

(51) Int. Cl. G01C 21/00

(52) U.S. Cl. CPC G01C 21/3815

(57) ABSTRACT

A method and device for creating a digital map representing one or more traffic routes. Each traffic route is composed of traffic route segments. A method for operation of an automated vehicle is also described.

### CROSS REFERENCE

The present application claims the benefit under 35 U.S.C. § 119 of German Patent Application No. DE 10 2023 208 926.2 filed on Sep. 14, 2023, which is expressly incorporated herein by reference in its entirety.

### FIELD

The present invention relates, inter alia, to a method for creating a digital map and to a method for operating an automated vehicle on the basis on this created map.

### SUMMARY

According to an example embodiment of the present invention, a method for creating a digital map representing one or more traffic routes, each traffic route being composed of traffic route segments, comprises a step of retrieving map data values representing a base map, the base map comprising traffic infrastructure information for the individual traffic route segments, and a step of determining tolerance specifications for each traffic route segment on the basis of the traffic infrastructure information, the tolerance specifications representing a maximum permissible deviation of independently determined positions or poses. The method for creating a digital map further comprises a step of creating the digital map by adding the predetermined tolerance specifications for the individual traffic route segments to the traffic infrastructure information and a step of providing the digital map for operating an automated vehicle.

A digital map is understood to mean a map that is present in the form of (map) data values on a storage medium. For example, the map is designed to comprise one or more map layers, wherein one map layer, for example, shows a map from the bird's eye view (course and position of roads, buildings, landscape features, etc.). This corresponds to a map of a navigation system, for example. A further map layer comprises, for example, a radar map, wherein surroundings features comprised by the radar map are stored along with a radar signature. A further map layer comprises, for example, a lidar map, wherein surroundings features comprised by the lidar map are stored along with a lidar signature.

In one example embodiment of the present invention, the map is designed as a highly accurate map. The highly accurate map is in particular designed in such a way that it is suitable for the navigation of an automated vehicle. This is understood, for example, to mean that the highly accurate map is designed to determine a highly accurate position of the automated vehicle by comparing stored surroundings features with detected sensor data values of this automated vehicle. For this purpose, the highly accurate map, for example, comprises said surroundings features along with highly accurate position specifications (coordinates).

A highly accurate position is understood to mean a position which is accurate within a specified coordinate system, e.g., WGS84 coordinates, in such a way that this position does not exceed a maximum permitted uncertainty. The maximum uncertainty may depend on the surroundings, for example. Furthermore, the maximum uncertainty can depend, for example, on whether a vehicle is operated manually or in a partially, highly or fully automated manner (corresponding to one of SAE levels 1 to 5). In principle, the maximum uncertainty is so low that safe operation of the automated vehicle is in particular ensured. For a fully automated operation of the automated vehicle, the maximum uncertainty is, for example, in an order of magnitude of about 10 centimeters.

Retrieving map data values is understood to mean, for example, that an existing base map is (down) loaded in the form of data values from a storage medium or is loaded into a buffer or working memory for processing (here: creating a digital map).

A surroundings feature is, for example, understood here to mean an infrastructure feature (roadway boundary lines, guardrails, etc.) and/or a traffic sign (road signs, traffic lights, etc.) and/or a structural feature (buildings, bridges, tunnels, etc.) and/or a further feature that can be detected by means of a surroundings sensor system.

Surroundings is understood here to mean at least one region—in particular along the traffic route—which can be driven on by vehicles. The surroundings comprise not only the traffic route itself, but also regions along the traffic route that can also be detected by means of a surroundings sensor system when driving along the traffic route. A surroundings sensor system is understood to mean at least one video sensor and/or at least one radar sensor and/or at least one lidar sensor and/or at least one ultrasonic sensor and/or at least one further sensor that is designed to sense the surroundings of a vehicle in the form of surroundings data values. In one possible embodiment, the surroundings sensor system comprises, for example, a computing unit (processor, working memory, hard drive) with suitable software and/or is connected to such a computing unit for this purpose.

A traffic route is, for example, a single-lane or multi-lane road. A region along a traffic route is understood to mean, for example, the traffic route itself along with a strip to the left and/or right of the traffic route. The width of the strip depends, for example, on the specific configuration of the surroundings and/or the sensor range of the individual vehicles. As a rule, this strip includes surroundings features such as traffic signs, etc. A traffic route segment is understood to mean, for example, a section of a traffic route of a specific length and/or between two intersections and/or between two entrances or exits, etc. of the corresponding traffic route.

Providing the digital map is understood to mean that the digital map can be requested and/or received by a vehicle, in particular an automated vehicle.

An automated vehicle is understood to mean a semi-, highly or fully automated vehicle according to one of the SAE levels 1 to 5 (see standard SAE J3016).

The method according to the present invention described here is based on the assumption that the position of an (automated) vehicle is determined using (at least) two different (redundant) position-determining methods. The position-determining methods used can be carried out, for example, by means of a GNSS-based method and/or by comparing sensor data with a correspondingly designed localization map (see, for example, above: highly accurate map) and/or by means of other methods. In particular, one method can be designed as a “main method” for determining a pose or position and at least one further method can be designed as a plausibility-check method for determining a pose or position.

The poses or positions determined in this way are compared geometrically, with the difference-which results from the previously performed comparison-then being compared with a predetermined maximum deviation. If the maximum deviation is assumed to be the same for all traffic route segments, the smallest possible value must therefore be assumed in order to ensure appropriate safety when operating an automated vehicle.

The method according to the present invention disclosed herein now advantageously solves the problem of providing a method for creating a digital map which provides different maximum deviations for individual traffic route segments, the deviations being adapted to the respective traffic route segments.

This problem is solved by means of the method according to the present invention by determining the corresponding tolerance specifications for each traffic route segment on the basis of the traffic infrastructure information. The advantage of this is that the plausibility check of a self-localization of an (automated) vehicle does not have to be carried out everywhere with “worst-case” requirements for the maximum deviation. Instead, appropriate safety or accuracy is ensured by means of a locally adjusted maximum deviation. At the same time, the requirement can be relaxed at other locations (other traffic route segments) where this precision is not required for safety reasons.

According to an example embodiment of the present invention, preferably, the traffic infrastructure information at least partially comprises configurations and/or usage specifications of corresponding infrastructure of the traffic route segments. The configuration of a traffic route segment is understood to mean, for example, the width of the roadway and/or the condition of the surface and/or the number and radius of bends and/or the presence of parking bays at the edge of the traffic route and/or other features. Usage requirements are understood to mean, for example, speed limits and/or no-passing zones and/or . . . and/or other (legal) requirements.

According to an example embodiment of the present invention, preferably, the tolerance specifications comprise a longitudinal tolerance and a transverse tolerance. This is understood to mean that the maximum permissible deviation for the longitudinal or transverse direction relative to the main direction of travel stored in the map is determined differently. This makes it possible, for example, to require a particularly high level of precision in the longitudinal direction at an intersection and/or at a stop line. Likewise, on a freeway, for example, a larger maximum permissible deviation in the longitudinal direction can be tolerated, while the lateral maximum permissible deviation in the transverse direction must be relatively smaller to ensure that a corresponding vehicle always stays within its lane.

According to an example embodiment of the present invention, preferably, the tolerance specifications are additionally determined on the basis of vehicle- and/or vehicle-movement-specific parameters. For example, the tolerance specifications can be determined on the basis of speed values in such a way that the digital map includes the maximum deviations on the basis of speed values (so that, when using the corresponding map, the maximum deviation is predetermined on the basis of the actual speed of the vehicle).

According to an example embodiment of the present invention, a device, in particular a computing unit, is configured to perform all steps of the method for creating a digital map according to the present invention. A computing unit means, for example, a server or a server network or a cloud.

According to an example embodiment of the present invention, the device or computing unit comprises a processor, working memory, storage medium, and suitable software in order to perform the method according to one of the embodiments of the present invention disclosed herein. Furthermore, the device comprises an interface in order to transmit and receive data values by means of a wired and/or wireless connection, for example with corresponding devices of vehicles (control units, communication devices, surroundings sensor system, navigation system, etc.) and/or further off-board devices (server, cloud, etc.).

Furthermore, a computer program is provided, comprising commands that, when the computer program is executed by a computer, cause the computer to perform a method according to one of the embodiments of the method for creating a digital map according to the present invention. In one example embodiment of the present invention, the computer program corresponds to the software comprised by the second device.

Furthermore, a machine-readable storage medium on which the computer program is stored is provided according to the present invention.

According to an example embodiment of the present invention, the method for operating an automated vehicle comprises a step of determining a first pose or position of the automated vehicle, a step of determining a second pose or position of the automated vehicle, and a step of determining a (geometric) difference between the two positions. The method for operating an automated vehicle further comprises a step of determining a maximum permissible deviation by means of a digital map created according to the method for creating a digital map according to the present invention, a step of comparing the difference with the maximum permissible deviation, a step of determining a driving strategy on the basis of the previously performed comparison, and a step of operating the automated vehicle on the basis of the driving strategy.

Operating an automated vehicle, in particular depending on the driving strategy, is understood to mean, for example, executing a lateral and/or longitudinal control of the automated vehicle, wherein the lateral and/or longitudinal control takes place in such a way that the automated vehicle moves along a trajectory. In one possible embodiment, the operation also comprises, for example, the execution of safety-relevant functions (“arming” an airbag, fastening seat belts, etc.) and/or further (driving assistance) functions.

A trajectory is understood to mean, for example, in relation to a map, a line that the automated vehicle follows. In one embodiment, this line relates, for example, to a fixed point on the automated vehicle. In a further possible embodiment, a trajectory is understood to mean, for example, a travel route envelope through which the automated vehicle drives.

In one possible embodiment of the present invention, the driving strategy additionally comprises an indication of a speed at which the automated vehicle should move along the trajectory.

Advantageous developments and example embodiments of the present invention are disclosed herein.

### BRIEF DESCRIPTION OF THE DRAWINGS

Exemplary embodiments of the present invention are illustrated in the drawings and explained in more detail in the following description.

FIG. 1 shows an exemplary embodiment of the method according to the present invention for creating a digital map in the form of a flow chart.

FIG. 2 shows an exemplary embodiment of the method according to the present invention for operating an automated vehicle in the form of a flow chart.

### DETAILED DESCRIPTION OF EXAMPLE EMBODIMENTS

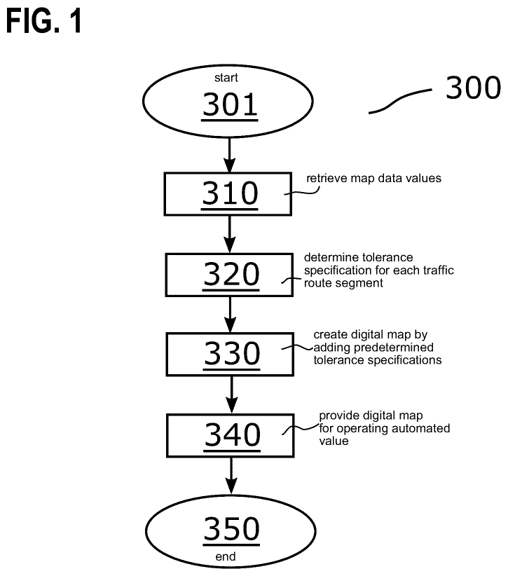

FIG. 1 shows an exemplary embodiment of a method 300 for creating 330 a digital map representing one or more traffic routes, each traffic route being composed of traffic route segments.

In step 301, the method 300 starts.

In step 310, map data values representing a base map are retrieved, the base map comprising traffic infrastructure information for the individual traffic route segments.

In step 320, tolerance specifications for each traffic route segment are determined on the basis of the traffic infrastructure information, the tolerance specifications representing a maximum permissible deviation of independently determined positions.

In step 330, the digital map is created by adding the predetermined tolerance specifications for the individual traffic route segments to the traffic infrastructure information.

In step 340, the digital map for operating an automated vehicle is provided.

In step 350, the method 300 ends.

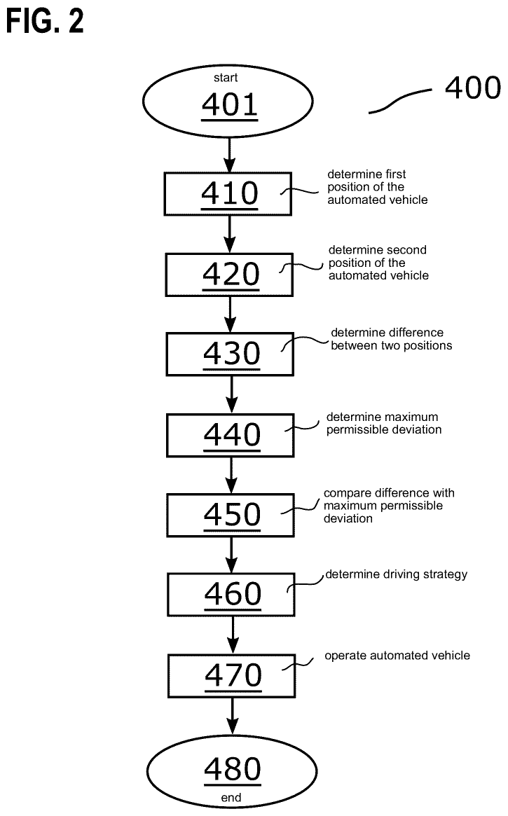

FIG. 2 shows an exemplary embodiment of a method 400 for operating 470 an automated vehicle.

In step 401, the method 400 starts.

In step 410, a first position of the automated vehicle is determined.

In step 420, a second position of the automated vehicle is determined.

In step 430, a difference between the two positions is determined.

In step 440, a maximum permissible deviation is determined by means of a digital map created according to FIG. 1.

In step 450, the difference is compared with the maximum permissible deviation.

In step 460, a driving strategy is determined on the basis of the previously performed comparison.

In step 470, the automated vehicle is operated on the basis of the driving strategy.

In step 480, the method 400 ends.

What is claimed is:

1. A method for creating a digital map representing one or more traffic routes, each traffic route including traffic route segments, the method comprising the following steps:
retrieving map data values representing a base map, the base map including traffic infrastructure information for the traffic route segments individually;
determining tolerance specifications for each individual traffic route segment based on the traffic infrastructure information, the tolerance specifications representing a maximum permissible deviation of independently determined positions;
creating the digital map by adding the predetermined tolerance specifications for the individual traffic route segments to the traffic infrastructure information; and
providing the digital map for operating an automated vehicle.

2. The method according to claim 1, wherein the traffic infrastructure information at least partially includes configurations and/or usage specifications of corresponding infrastructure of the traffic route segments.

3. The method according to claim 1, wherein the tolerance specifications include a longitudinal tolerance and a transverse tolerance.

4. The method according to claim 1, wherein the tolerance specifications are additionally determined based on vehicle- and/or vehicle-movement-specific parameters.

5. A device including a computing unit, configured to create a digital map representing one or more traffic routes, each traffic route including traffic route segments, the device configured to:
retrieve map data values representing a base map, the base map including traffic infrastructure information for the traffic route segments individually;
determine tolerance specifications for each individual traffic route segment based on the traffic infrastructure information, the tolerance specifications representing a maximum permissible deviation of independently determined positions;
create the digital map by adding the predetermined tolerance specifications for the individual traffic route segments to the traffic infrastructure information; and
provide the digital map for operating an automated vehicle.

6. A non-transitory machine-readable storage medium on which is stored a computer program for creating a digital map representing one or more traffic routes, each traffic route including traffic route segments, the computer program, when executed by a computer, causing the computer to perform the following steps:
retrieving map data values representing a base map, the base map including traffic infrastructure information for the traffic route segments individually;
determining tolerance specifications for each individual traffic route segment based on the traffic infrastructure information, the tolerance specifications representing a maximum permissible deviation of independently determined positions;
creating the digital map by adding the predetermined tolerance specifications for the individual traffic route segments to the traffic infrastructure information; and
providing the digital map for operating an automated vehicle.

7. A method for operating an automated vehicle, comprising the following steps:
determining a first position of the automated vehicle;
determining a second position of the automated vehicle;
determining a difference between the first position and the second position;
determining a maximum permissible deviation using a digital map, the digital map being created by:
retrieving map data values representing a base map, the base map including traffic infrastructure information for the traffic route segments individually,
determining tolerance specifications for each individual traffic route segment based on the traffic infrastructure information, the tolerance specifications representing a maximum permissible deviation of independently determined positions, and
creating the digital map by adding the predetermined tolerance specifications for the individual traffic route segments to the traffic infrastructure information;
comparing the difference with the maximum permissible deviation;
determining a driving strategy based on the comparison; and
operating the automated vehicle based on the driving strategy.
